(19) United States
(12) Patent Application Publication
(10) Pub. No.: US 2004/0028598 A1
(43) Pub. Date: Feb. 12, 2004

(54) Method and assembly for processing quantum-mechanical information units

(76) Inventors: Wolfgang Harneit, Berlin (DE); Klaus-Peter Dinse, Heidelberg (DE); Bernd Mertesacker, Berlin (DE); Markus Waiblinger, Berlin (DE); Alois Weidinger, Berlin (DE)

Correspondence Address: Law Offices of Karl Hormann, PO Box 381516, Cambridge, MA, 02238-1516, US

(21) Appl. No.: 10/432,063

(22) PCT Filed: Nov. 16, 2001
(86) PCT No.: PCT/DE01/04381

(30) Foreign Application Priority Data
Nov. 19, 2000 (DE) 100 58 243.5

(51) Int. Cl. C01B 31/02

(52) U.S. Cl. 423/445 B

(57) ABSTRACT

Solid matter quantum computers with local control accesses are based on the fixed arrangement of spins as quantum mechanical information units. Local control accesses allow the dynamic modification of the resonance frequency of individual spins and the interlinking of spins for the individual addressing of spins in order to carry out computer operations. Known local control accesses perform poorly and are difficult to produce. The invention uses the electron spins of enclosure atoms in endohedral fullerenes, which are electromagnetically interlinked (J) by a magnetic dipole-dipole interaction (105). The resonance frequency (ω) is regulated by a controlled electron transfer to or from the cage of the endohedral fullerenes (104) with an adjustable residence time. The electromagnetic link (J) is regulated by a controlled angular modification v (108) between the orientation of the external magnetic field (B) (109) and the binding vector (r) (107) of neighboring fullerenes (104). Electron spin quantum computers envisage matrix-type arrangements of endohedral fullerenes (104) with different resonance frequencies (ω). The addressing control accesses can, in particular, be configured as large-surface electrodes (104) and the linking control accesses can be achieved mechanically, optically or chemically.

### BACKGROUND OF THE INVENTION

1. Field of the Invention

The invention relates to a method of processing quantum-mechanical information units by their codification in their spin position which may be affected in its outer magnetic field by irradiation of electromagnetic pulses of resonance frequency, of addressable spins locally associated with a substrate with a control of the resonance frequency of individual spins and of the electromagnetic coupling between neighboring spins. Furthermore, the invention relates to an arrangement structured as a spin-based quantum computer for practicing the method with local addressing and control accesses for controlling the resonance frequency of individual spins and local coupling control accesses for controlling the electromagnetic coupling between neighboring spins.

2. The Prior Art.

Quantum-mechanical information processing is a very new field (see general information article “Quantum Information and Computation”, C. H. Bennett, D. P. DiVincenzo, Nature/Vol. 404/Mar. 16, 2000, pp. 247-255). A subordinated field deals with the processing of quantum-mechanical data units (so-called “qubits”) by their codification in the individual spin positions in spin-quantum computers. In this kind of computer, data is transmitted in an outer magnetic field by electromagnetic pulses of resonance frequency (phenomenon of magnetic resonance as known, for instance, from nuclear spin tomography). Several realizations of spin-quantum computers have been described in literature (see, for instances, Bennett and DiVincenzo, supra). However, most of them are liquid quantum computers whose data carrying nuclear spin systems are of a liquid phase. No local dynamic control of the spins by local control accesses is possible in such computers. For that reason, during irradiation of an electromagnetic pulse the data is always transmitted simultaneously to all spins at identical resonance frequency. Therefore, special molecules must be used in which the active nuclear spins, because of their local surroundings, are of a statically different resonance frequency. In these computers the coupling of the spins among each other which is necessary for actual data processing, is unalterably predetermined by the molecule.

Solid substance computers with local control accesses are substantially more powerful than liquid quantum computers. In known embodiments, these quantum computers are not based upon the predetermined architecture of a molecule but upon the arrangement of the spins by methods of nano-structuring of solids, as is known, for instance, in semiconductor technology. In such computers, local control accesses permit the dynamic modification of the resonance frequency of individual spins as well as the coupling of spins among each other. This makes possible greater degrees of freedom in the design of the computers and, especially, the scaling of the concepts of few to many qubits. The addressability of the spins is determined by control their addresses. Only spins of the resonance frequency can be addressed. Where the resonance frequency is altered by control means, the corresponding spin is “switched off” and is no longer addressable by the original resonance frequency. A computational process may be affected by controlling the coupling between neighboring spins. In particular, the coupling may be switched off during the read-out during setting of the spins following the computational process. In the present context, “neighboring spins” connotes a direct neighborhood of two spins as well as an indirect neighborhood of several spins arranged next to each other.

A method of spin position codification by control of the resonance frequency of the individual spins and of the electromagnetic coupling between individual spins and a corresponding realization of electronic control accesses is known from WO9914858 (see also “A Silicon-Based Nuclear Spin Quantum Computer”, B. E. Kane, Nature, Vol. 393, May 14, 1998, pp. 133-137). The nuclear spin of individual phosphor atoms in silicon is used as a qubit. The method is based upon the coupling of the nuclear spin system used for codifying by influencing its electron environment by controllable electric fields. For controlling the resonance frequency of the individual addressable nuclear spins the hyper fine coupling of a single nuclear spin system with its valence electron is changed directly by the application of an electric field. For this purpose, the addressing control access is structured as an electrode positioned precisely over a phosphor atom and connected to a control voltage. In the case of controlling the electromagnetic coupling between neighboring nuclear spins, the interaction between neighboring nuclear spins is altered again by the local application of an electric field. For this purpose, a coupling control access also structured as an electrode, which must be positioned precisely between the interacting nuclear spins, is charged with a control voltage. One difficulty in respect of this known method and its realization resides in the fact that the controlling influence of the various couplings by way of the electronic control accesses is very low. Thus, the technical realization of the control accesses is subject to extremely high demands, particularly in respect of the placement of individual phosphor atoms at defined positions within the silicon substrate. Moreover, the dimensions in the range of but a few nanometers for the control accesses structured as electrodes cannot at present be realized.

### OBJECTS OF THE INVENTION

For the reasons mentioned there is a necessity in spin quantum computers on the one hand to be able selectively to address a predetermined data carrier (addressing by way of the controlled change of the spin resonance frequency) and, on the other hand, deliberately to turn the coupling between the data carriers on and off or to modify its strength (control of the spin coupling). In respect of the invention, the problem is to be seen in being able to provide a particularly powerful and efficient method of great flexibility. A preferred arrangement for executing the method is to be able to execute the flexibility in a simple manner. In particular, however, the method in accordance with the invention and the arrangement for practicing it is to avoid the described weak points of the known method and of its practice.

### SUMMARY OF THE INVENTION

For solving this complex of problems, a method of the kind described supra for processing quantum-mechanical data units by resonance frequency control of individual spins and of the electromagnetic coupling between neighboring spins therefore provides for utilizing the addressable electron spin of free atoms enclosed within the interior space of the cage of endohedral fullerenes for processing data, which interior space is coupled to the electron spins of neighboring enclosed atoms by magnetic dipole-dipole interaction, and that the resonance frequency control takes place by a controlled electron transfer to or from the cage of the endohedral fullerenes at an adjustable dwell time and/or by controlling the electromagnetic coupling by a controlled change of angle between the orientation of the outer magnetic field and the connection vector of neighboring fullerenes.

Furthermore, in an arrangement structured as a spin-based quantum computer for executing the method of solving the problems, the addressable spins are formed by electron spins of free atoms enclosed in the interior of the cage of endohedral fullerenes of identical or different structure which, including the substrate, are rigidly connected to each at a predetermined spacing and position relative to each other in a matrix of two- or three-dimensional expression, and that the addressing and/or coupling control accesses are structurally formed in accordance with the selected form of the control of the resonance frequency of the individual spins and of the electromagnetic coupling between neighboring spins.

Advantageous alternatives and improvements of the method in accordance with the invention and of the preferred arrangement may be taken from the respective ensuing subclaims. In this connection, the terms “addressing control access” and “coupling control access” have been chosen in the sense of a general accessibility to the respective controllable sites (“to have access to”). The realizations of these accesses may be of the most variegated types, depending upon the selected type of control, and may extend from electrical inputs, such as simple web-like electrodes, to optically, thermally or chemically functioning inputs, or inputs functioning in a different manner.

An essential characteristic of the method in accordance with the invention is the utilization of electron spin systems for processing data compared to the known utilization of nuclear spin systems of a relatively low sensitivity. The electron spin systems utilized are stable endohedral fullerenes. Fullerenes are cage-like molecules of carbon atoms. The best known one is the C₆₀-molecule. Atoms and molecules may be enclosed by different methods in the interior of these molecules. The molecules formed in this manner are called endohedral fullerenes. In the endohedral fullerenes applied in the method in accordance with the invention, the enclosed atom is not tied to the internal side of the fullerene; rather, it is freely positioned in the center of the cage which results, for the application, in favorable properties of the electron spin of the enclosed atom (see EP 095,241). The excellent shielding of the electron spin from its environment results in a long coherence time in which the state of all relevant spins remains phase coherent.

In addition, the endohedral fullerenes used here have magnetic dipoles which open up the possibility of a magnetic dipole to dipole coupling with neighboring electron spins and which make possible quantum-mechanical calculations.

By use of the electron spin system, the method in accordance with the invention makes possible the realization of two concepts for quantum calculations: On the one hand, the entire data processing of input and output, calculation and storage may take place with but one electron spin. In that case the nuclear spins may be ignored or deactivated. On the other hand, the nuclear spins may be drawn upon, in extending the first concept, for the long-time storage of intermediate results. Since the coherence time of nuclear spins are longer than those of electron spins, the nuclear spins may be used as “integrated quantum hard disc”. However, fast calculation times are required to stay ahead of the increasing incoherence by the electron spins with their somewhat shorter coherence time. Further advantages of an electron spin based system are the stronger polarizability of the electron spins up to a complete polarization, which avoids complex initialization routines at the beginning of the process for testing the spin conditions as known, for instance, from the above-cited WO9914858, and the substantially higher sensitivity of the electron spin resonance (ESR) associated with the stronger polarizability as compared with the nuclear spin resonance (NMR). This results in improved signal detection.

The other essential complex of characteristics of the method in accordance with the invention relates to the kind of control of addressing the individual spins and the coupling between neighboring spins. The controlled transfer of one or more electrons to the endohedral fullerene the spin system thereof is significantly altered either by a significant shift of the resonance line or by it being broadened extremely so that it no longer responds to an irradiated frequency. It is thus possible by an electron transfer to the fullerene to switch off the probability of addressing the electron spin and thereby control its addressability.

While it is known from the paper “Synthesis and EPR studies of N@C₆₀ and N@C₇₀ radial anions” by P. Jakes et al. (XIV^{th} International Winterschool on Electronic Properties of Novel Materials, Kirchberg (Austria), 2000) that C₆₀ molecules can receive one or more electrons (function as electronic acceptors) and that a new condition is thereby created which leads to a shift of the resonance frequency of the enclosed atom (disappearance of the resonance line of N@C₆₀ during electron transfer). However, neither conclusions nor suggestions for a possible use were derived from this realization. Also, nothing is known from literature regarding a realization of controlling the coupling between neighboring spins by changing the angle in a dipole to dipole coupling. However, knowledge of the behavior of dipole fields in dominant magnetic fields is generally known and must be associated with basic knowledge of physics. The electron spins has a magnetic dipole moment which generates a magnetic field which rapidly deteriorates in proportion to distance. This field affects every neighboring electron spin (dipole to dipole coupling or dipole to diploe interaction). As a consequence of the geometry of the dipole field, the coupling strength between two qubits depends upon the angle between the connecting line of the fullerenes and the orientation of the alignment of the generated dipole. In particular, the coupling strength is J=0 when the “magnetic” angle is 54.7°. By comparison, the coupling J is at a maximum when the angle is zero. The orientation of the electron spin follows the orientation of the magnetic field applied from the exterior (equal or opposite). By a controlled setting of the angle between the connecting line of two fullerenes and the orientation of the outer magnetic field, the method in accordance with the invention makes it possible to control or switch the strength of the dipole to dipole coupling.

Controlling the addressing of the spins and their coupling allows for a clocked control in addition to executing a one-time control operation, for instance for initializing or resetting. The control at a predetermined clock rate is analogous to the clock rate of conventional electronic calculating for enabling an optimum calculation course at the highest possible synchronism.

The method in accordance with the invention is practiced in a spin quantum computer. For this purpose a plurality of endohedral fullerenes are arranged as basic components in a selectable relationship to each other which results in a rigid body structure with a geometrically well-defined spin system. Depending on the structure similar of different endohedral fullerenes may be used which would make it possible to assign the static addressability, particularly of different classes of qubits which are characterized by an identical local environment. By selecting the spacing and the relative position of the fullerenes with respect to each other it is possible to achieve a static presetting of the coupling between the qubits. Various V-group elements occurring in nature (¹⁴N, ¹⁵N, ³¹P) may be enclosed in a fullerene. Furthermore, the fullerene molecule may be varied (C₇₀ instead of C₆₀) or chemically modified by adduct forming by adding chemical groups (addends). This would provide different individually designed molecules each of a characteristic resonance frequency as statically distinguishable qubits. By the possibility of producing dimers of fullerenes (fullerene oligomers) or fullerene polymers (collectively fullerene systems), it is possible also to realize structures of defined dipole coupling between electron spins mounted therein. Since in principle the number of participating spins may be freely selected, it is possible thereby to produce linear, web-like and spatial qubit systems of any size. Moreover, in this manner it is possible to realize many identical qubit systems in a single step, in a manner efficacious for selection processes. In case the fullerene oligomers are mounted into a suitable matrix in an oriented manner, the result is a multiple n-dimensional qubit solids system.

Various possibilities are given for arranging such fullerene systems which may also be produced by chemical linking of the fullerenes. In a basic arrangement, they may be structured as a linear chain with a uniform spacing between the individual fullerenes since in that fashion the connection vector between neighboring fullerenes is of the same size and direction. It is thus possible for all electron spins to select the “magnetic angle” for aligning the magnetic fields simultaneously which results in a total decoupling of all spins. In a variant, grids of uniform honeycomb structure will be admitted at the junctions of which the fullerenes are positioned. The honeycombs may be of any configuration. But, preferably, they will be rectangular (which results in “rectangular” junctions) or triangular. For each configuration, undesired couplings may be canceled again by appropriate irradiated pulse sequences. In another variant, grids may be admitted in which several fullerenes are disposed as a linear chain along a mesh. In that case the chains in themselves may be totally decoupled. Because of the dependency of the interaction on spacing no interaction will occur with the next chain since it is disposed too far away. Embodiments of chains coupled in a special manner and spatial arrangements are possible as well.

When controlling the addressing of individual electron spins by changing the resonance frequency of a qubit, the resonance frequency—without additional exterior measures—will be affected by the type and chemical reaction of the fullerene molecule, the type of enclosed atom and the arrangement of neighboring qubits relative to each other. When including additional exterior measures the resonance frequency can be changed by transmission of one or more electrons to the fullerene. This process can be controlled by electrical control of the charge transfer, by selection of the dwell time of electrons on a fullerene (even chemically affected) and by optical selective excitation of the charge carriers. By combination of the individual possibilities, differentiated and complex protocols may thus be realized for calculating with the quantum computer. For instance, several statically distinguishable qubits may be assembled in one group, which together are switched by a control access which may, for instance, be structured as an electrode. This would make it possible to make the electrodes larger than the electrode of the prior art with problematic dimensions in the nanometer range. A common control electrode may, for instance, control the charge leakage only (blocking diode), whereas the electron influx is generated by the optical excitation without a physical electrode. In that case, the control influx will then be realized by a controllable light source.

Hereafter, examples will be set forth for various possibilities and realizations of electron transfer to a fullerene for adjustable control of the addressability of the electron spin by changing its resonance frequency.

Electron Transfer by an Electric Field

The environment of the fullerene molecules and, more particularly, the substrate or an electrolyte surrounding the fullerenes, are a suitable source and sink for the electrons. By applying a control voltage one or more electrons may be transferred to or removed from the fullerenes. Where electrolytes are being used, attention must be paid to the anchoring of the fullerenes, as by the use of bond-strengthening addends, for instance.

Coupling of Fullerenes to do Donor Molecules

It is known from fullerene research that fullerenes in connection with polymers may be used for the separation of pairs of electron holes in photovoltaic applications. The charge transfer to a fullerene molecule may be extremely quick (a few femto seconds). For this reason, electron transfer and discharge via polymer based feed lines is possible, whereby a geometric rectification of the electron structure may be achieved. The dwell time of the electrons on the fullerene molecule may be set by a suitable selection of materials. If necessary, it is possible to create a direct chemical bong between the fullerenes and the polymer.

Optical Switching by Excitation of Electron Hole Pairs

The optical excitation of electron hole pairs in the donor molecules mentioned above is known from solar cell research. It enables optical switching of the addressing control accesses. In this connection, donor molecules of different color sensitivities, i.e. different absorption wavelengths, may be used to provide for a simultaneous or special optical switching of individual classes of qubits.

Examples will hereafter be set forth of different possibilities and realizations of altering the angle of the magnetic dipole to dipole coupling for adjustably controlling the coupling between two electron spins.

Switching by Tilting of the Substrate or of the Outer Magnetic Field

The simples case consists of all qubits being present in a linear array. In that case the connection vector of all neighboring qubits is identical. If the orientation of the array is changed relative to the magnetic field (by tilting the substrate or by tilting of the magnet) the coupling of all qubits among each other is changed simultaneously. The magnetic field may be disposed parallel to the array (maximum coupling of all qubits) or at an angle of 54.7° (“switched-off coupling”). Switching between the angles 45°±9.7° is also conceivable, which causes the coupling to be switched between zero and half the maximum coupling at a median value of one fourth the maximum coupling at 45°. Furthermore, the substrate may be divided into several areas (parallel rows of greater spacing than between qubits in one row) which are tilted independently of each other. In particular, liquid crystals whose ability to be oriented by electric fields is used in LCD displays, for instance, may be used for this purpose. Instead of mechanically altering the orientation of the connecting axis of the qubits against the outer magnetic field, it possible to change the orientation of the magnetic field. By applying an additional field which is orthogonal relative to the quanticising main field the effective field orientation may be changed deliberately. Its advantage is that such changes are possible in a time scale of microseconds.

Switching by Shifting of Individual Fullerenes or Groups Thereof

Individual molecules or groups of molecules may yet be switched in a different manner: by shifting of a fullerene along the field vector (spin orientation). This involves merely a change in the connecting line between two qubits, but the orientation of the electron spins does not change. The shift may take place in various ways: By piezo-electric elements, mechanical elements such as single or multiple protrusion tips of scanning probe microscopes, mechanical vibrators of the substrate at varying power transmission to the fullerene molecules (resilient addends between substrate and fullerene), direct local excitation of oscillating modes in spring-like addends or application of surface acoustic waves (SAW)—structural components provided with a commercially available oscillating quartz of frequencies of >1 GHz.

### DESCRIPTION OF THE SEVERAL DRAWINGS

The novel featerures which are considered to be characteristic of the invention are set forth with particularity in the appended claims. The invention itself, hoever, in respect of its structure, construction and lay-out as well as manufacturing techniques, together with other objects and advantages thereof, will be best understood from the following description of preferred embodiments when read with reference to the appended drawings, in which:—

FIG. 1a is a sectional view schematically depicting an electron spin quantum computer with endohedral fullerenes;

FIG. 1b depicts two endohedral fullerenes the electron spins of which are coupled to each other by magnetic dipole to dipole interaction;

FIG. 2 is a cross-sectional view of an electron spin quantum computer with a coupling access for changing the coupling strength of the qubits by:

FIG. 2a tilting of the substrate relative to the magnetic field orientation;

FIG. 2b deflection of the fullerene relative to its neighbors;

FIG. 2c tilting of the outer magnetic field relative to the substrate;

FIG. 3 is a cross-sectional view of an electron spin quantum computer with an addressing control access using a common addressing electrode for a plurality of qubits which in their resonance frequency differ by:

FIG. 3a the spacings between the fullerenes differing;

FIG. 3b the enclosed atoms or the fullerene cages differing;

FIG. 3c differing addends being attached to endohedral fullerenes of the same type; and

FIG. 4 is a planar view of an electron spin quantum computer in accordance with the invention with a common addressing control access according to FIGS. 3a, 3b, 3c.

### DETAILED DESCRIPTION OF THE PREFERRED EMBODIMENTS

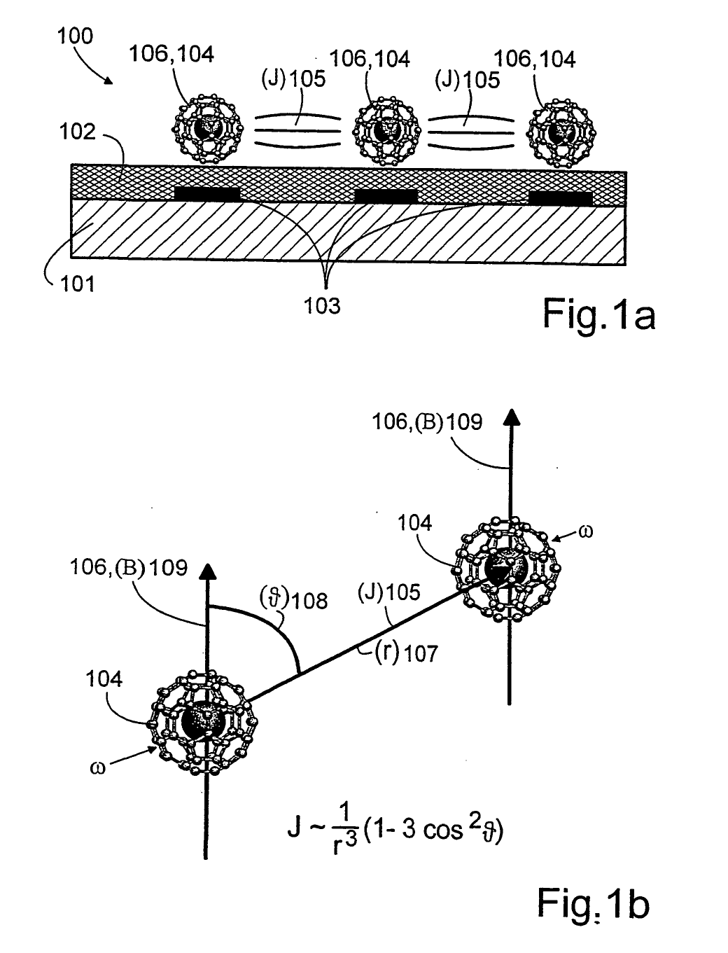

FIG. 1a schematically depicts an electron spin quantum computer 100 with endohedral fullerenes. Endohedral fullerenes 104 are arranged, separated by an oxide layer 102, on a substrate 101 above strip-shaped addressing electrodes 103 which form an addressing control access. In the embodiment shown, the fullerenes 104 are C₆₀-fullerenes with nitrogen N as the free enclosed atom (N@C₆₀). The fullerenes 104 used here have a magnetic moment coupled to the neighboring atom by way of dipole to dipole interaction (J) 105. By changing the magnetic coupling (J) 105 and/or the addressing of individual fullerenes 104 by changing the electron spin resonance frequency as a result of an electron transfer to the fullerenes 104, the electron spin quantum computer 100 may be deliberately affected for executing mathematical calculations.

FIG. 1b schematically depicts two endohedral fullerenes 104 the electron spins 106 of which are coupled to each other by way of a magnetic dipole to dipole coupling (J) 105. The electron spins 106 have a magnetic dipole moment which generates a magnetic field which quickly drops over distance. They are oriented similarly or opposite the orientation of an outer magnetic field (B) 109. The dipole to dipole interaction is dependent upon the distance vector (r) 107 of the two fullerene centers (enclosed atoms) and upon the angle (θ) 108 between the distance vector (r) 107 and the direction of the spins 106 by way of the mathematical formula (J) shown in the FIG. 1b.

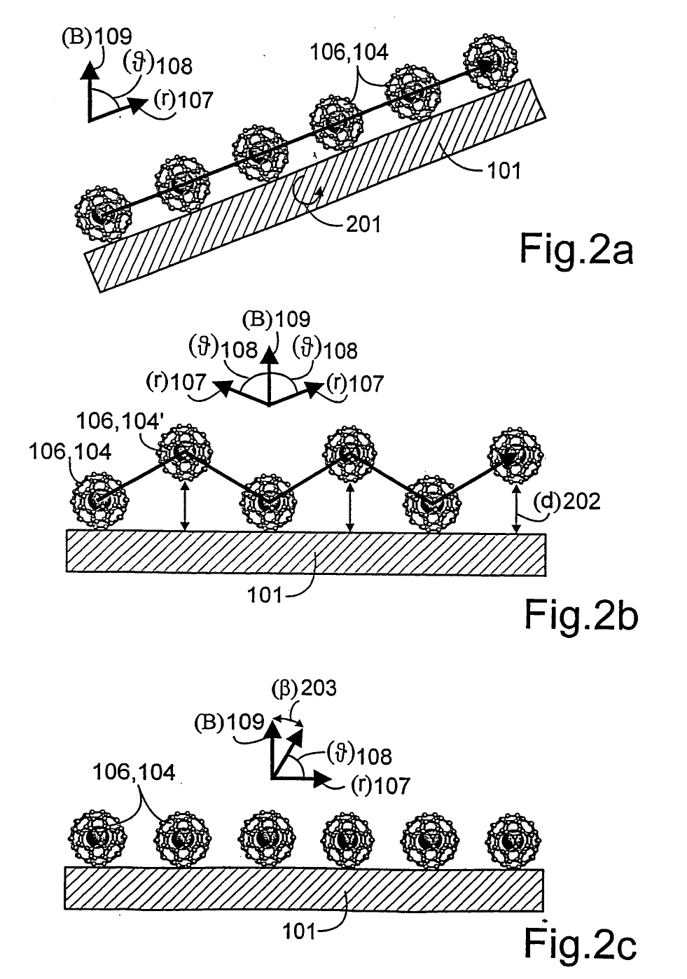

FIGS. 2a, 2b and 2c depict various possibilities of realizing a coupling control access for changing the coupling strength (J) of the qubits. In this case these are absolute and relative site position changes brought about by purely mechanical methods, such as, for example, rotating, tilting or lifting. Corresponding coupling control accesses are shown a tilting, rotating or lifting mechanisms which may follow generally known construction principles.

FIG. 2a depicts illustrates a change in the coupling strength (J) of the qubits 106 among each other by rotating or tilting the substrate 101 relative to the magnetic field orientation (B) 109. An arrangement of endohedral fullerenes 104 not unlike the one of FIG. 1a on a substrate 101 with a connection vector in (r) 107 is set by tilting 201 the substrate 101 relative to the axis of the outer magnetic field (B) 109 to a certain angle (θ). For angle θ=54.7° the coupling is zero; for angle θ=0° the coupling (J) is at maximum.

FIG. 2b depicts a change of the coupling strength (J) of a qubit 106 by deflection of a fullerene 104′ relative to its neighbors 104. Every second one of the fullerenes 104′ arranged on the substrate 101 is shifted along the orientation of the outer magnetic field (B) 109, i.e. in the present case it is vertically shifted by a certain value (d) 202 relative to the surface of the substrate 101. This results in an angle (θ) differing from zero between the connection vector (r) 107 and the orientation of the outer magnetic field (B) 109. The size of the angle (θ) 108 decides the coupling strength (J) between neighboring fullerenes 104,104′, which can thus be adjusted.

FIG. 2c illustrates a change in the coupling strength (J) of the qubits 106 by rotating or tilting the outer magnetic field (B) 109 relative to the substrate 101. Instead of tilting the substrate 101 together with the fullerenes 104 relative to the outer field 109 as in FIG. 2a, the magnetic field (B) 109 is here tilted by an angle (β) 203. The thus resulting angle (θ) 108 between the connection vector (r) 107 and the orientation of the outer magnetic field (B) 109 may be used for controlling the coupling (J) as described supra.

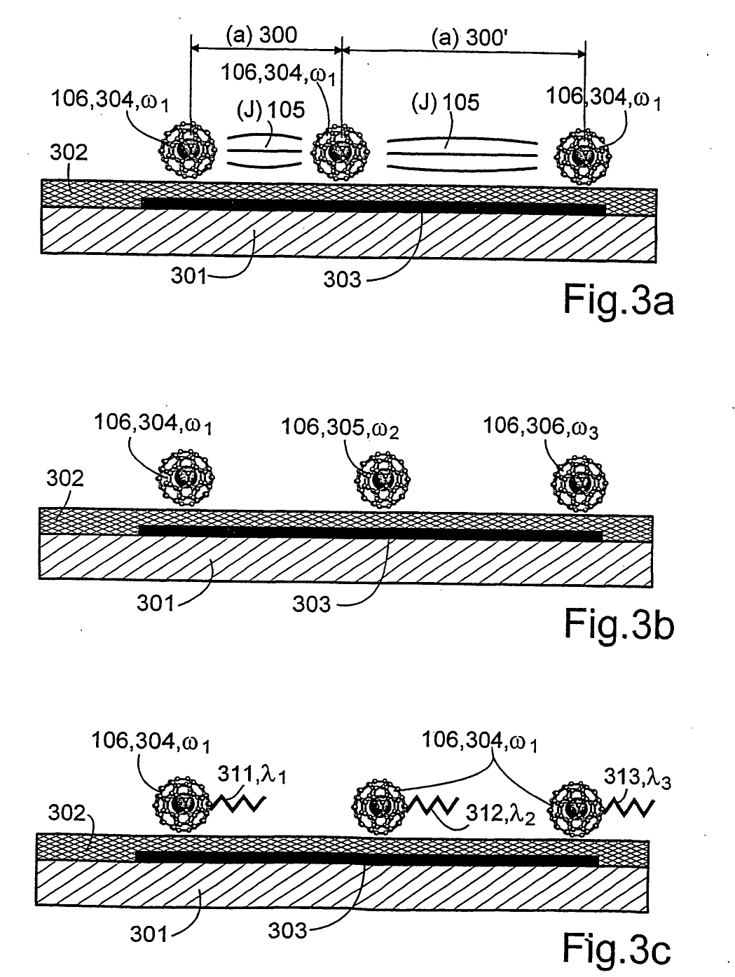

FIGS. 3a, 3b, and 3c depict various possibilities of realizing addressing control accesses for the deliberate addressing of the qubits 106. To this end, endohedral fullerenes 304, 305, 306 are arranged over a substrate 301, separated by an oxide layer 302. Among these is a web-like addressing electrode 303 common to all fullerenes 304, 305, 306 and positioned in the oxide layer 302, the electrode 303 being a possible realization of an addressing control access in cooperation with certain properties of the qubits 106.

FIG. 3a illustrates the use of a common addressing electrode 303 for several qubits 106 which differ in their static resonance frequency (ω) because of the difference in spacings (a) 300, 300′ between the fullerenes 304. The fullerenes 304 may be distinguished by the resonance frequency (ω) since because of different spacings (a) 300, 300′ there is a differing dipole to dipole interaction (J) 105 with neighboring atoms which shifts the resonance frequency (ω) of each fullerene 304 in a clear manner.

FIG. 3b shows the use of a common addressing electrode 303 for several qubits 106 which differ from each other in their resonance frequency (ω) because of difference between the enclosed atoms or between the fullerenes. The fullerenes 304, 305, 306 may be distinguished by their resonance frequency (ω₁, ω₂, ω₃) since they contain differing atoms (for instance nitrogen N or phosphorus P in C₆₀) or the atoms are disposed in different cages (e.g. nitrogen N in C₆₀ or 60₇₀).

FIG. 3c shows the use of a common addressing electrode 303 for a plurality of qubits 106 which are different in their static resonance frequencies (ω) by different addends 311, 312, 313 being connected to endohedral fullerenes 304 of the same type. The fullerenes 304 can be distinguished by their resonance frequencies (ω) since they are provided with different addends 311, 312, 313. In the embodiment shown, these addends 311, 312, 313 may be different in their photo sensitivity (absorption maximum λ₁, λ₂, λ₃) and would thus response selectively to colored light, so that the fullerenes are addressable correspondingly. Such fullerenes of different color sensitivity may then be arranged in groups of identical color sensitivity in squares on a substrate, so that corresponding address areas are formed (not shown in FIG. 3c). After light absorption an electron may be transferred to the cage of the fullerene 304 which changes its ESR frequency. In optical switching of the addressing control access by electron transfer the addressing control electrode 303 serves to control the discharge. This may also be realized without functioning electrically if the dwell time of the electrons on the fullerenes 304 is controlled differently, for instance by chemical manipulation of the addressing electrode 303.

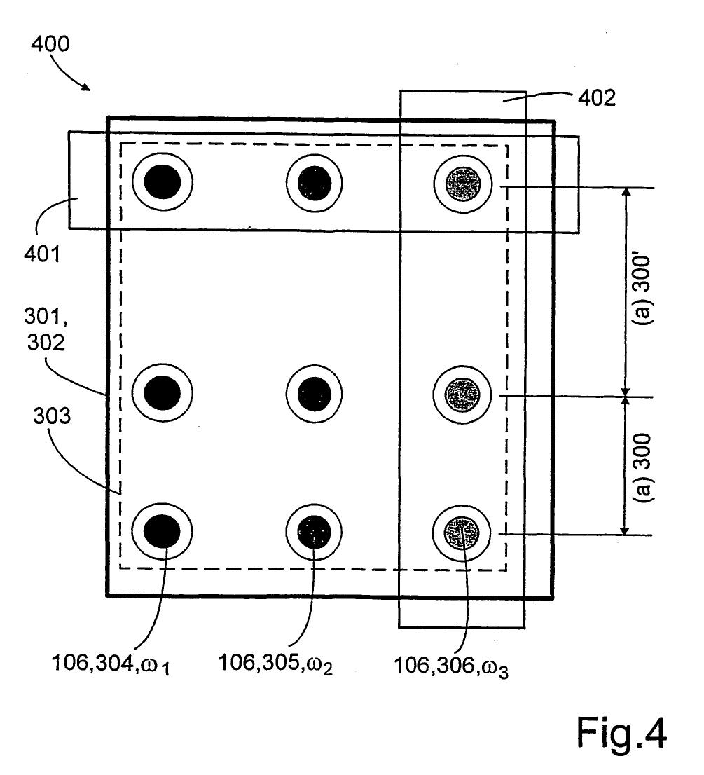

FIG. 4 is a schematic top elevational view of an electron spin quantum computer 400 in accordance with the realization protocol of FIGS. 3a and 3c. Endohedral fullerenes 304, 305, 306 of different types are arranged in rows 401 and columns 402 on a substrate on the oxide layer 302. Within a row 401 the fullerenes 304, 305, 306 differ from each other by their type, within a column 402 they differ by their spacing (a) 300, 300′. Both parameters (type and spacing) statically determine the distinction of the qubits 106 (electron spins) of the atoms enclosed in the fullerenes 304, 305, 306 in respect of their resonance frequency (ω₁, ω₂, ω₃) and their coupling (J). Because of the differing resonance frequencies (ω₁, ω₂, ω₃) of the qubits 106 the addressing access, which in the case at hand may be structured as a web-like electrode 303 embedded in the oxide layer 302, need only affect all qubits 106 in common.

1. A method of processing quantum mechanical data units by their coding in a spin position which may be affected in an outer electromagnetic field by irradiated electromagnetic pulses of resonance frequency, of addressable spins locally associated with a substrate and provided with a control of the resonance frequency of the individual spins and of the electromagnetic coupling between neighboring spins,
characterized by the fact that
for the data processing the addressable electron spin (106) of free atoms enclosed in the interior of the cage of endohedral fullerenes (104) is used which by magnetic dipole to dipole interaction (105) is coupled to the electron spins (106) of neighboring enclosed atoms, and that the control of the resonance frequency (ω) of the electron spins (106) takes place with adjustable dwell time by controlled electron transfer to or from the cage of the endohedral fullerenes (104) and/or that the control of the electromagnetic coupling (J) takes place by a controlled change of angle (θ) (108) between the orientation of the outer magnetic field (B) (109) and the connection vector (r) (107) of neighboring fullerenes (104).

2. The method of claim 1,
characterized by the fact that
the control takes place an a periodic clock rate.

3. The method of claim 1 or 2,
characterized by the fact that
the control of the resonance frequency (ω₁, ω₂, ω₃) of the individual electron spins (106) takes place without additional external means by selection of the type, variation or chemical modification of the endohedral fullerenes (304, 305, 306) as well as by the type of the enclosed atoms and/or by selection of the local association of neighboring fullerenes (304, 305, 306) for the static distinction of the individual electron spins (106).

4. The method of one of claims 1 to 3,
characterized by the fact that
the control of the resonance frequency of the individual electron spins is carried out by additional external measures as an electronic control of the electron transfer, by a chemical affection of the dwell time of the transferred electron on the cage of the fullerenes and/or by an optical selective excitation of the electron transfer for dynamically distinguishing the individual electron spins.

5. The method of claim 3 and 4,
characterized by the fact that
several statically distinguishable electron spins are in common subjected at least to one measure for the dynamic distinction.

6. The method of claim 4 and 5,
characterized by the fact that
that the electrons for the electron transfer by application of an electric control field originate with or are returned to the environment of the endohedral fullerenes.

7. The method of claim 4 or 5,
characterized by the fact that
that the electrons for the electron transfer by application of an electric control field originate with or are returned to polymer based donor molecules.

8. The method of claim 4 or 5,
characterized by the fact that
that the electrons for the electron transfer by application of an optical control field for the optical excitation originate with light sensitive, especially color sensitive polymer based donor molecules (311, 312, 313) coupled to the fullerenes (304).

9. The method of one of claims 1 to 8,
characterized by the fact that
differentiated and complex protocols for processing quantum mechanical data units may be made by combining different kinds of resonance frequency adjustments with and without additional external measures.

10. The method of one of claims 1 to 9,
characterized by the fact that
the control of the electrical coupling (J) between neighboring electron spins (106) is carried out by a controlled change of angle (θ) (108) between the orientation of the outer magnetic field (B) (109) and the connection vector (r) (107) of neighboring fullerenes (104) in an angular range between 0° and 54.7° by a change in position of individual or grouped fullerenes (104) relative to the outer magnetic field (B) (109).

11. The method of claim 10, characterized by the fact that the controlled angular change is carried out in an angular range of 45°±9.7°.

12. The method of claim 10 or 11,
characterized by the fact that
the relative change in position is carried out by tilting or changing the effective orientation (β) (203) of the outer magnetic field (B) (109) or by tilting (θ) (108) the substrate (101) with which the endohedral fullerenes are locally associated.

13. The method of claim 10 or 11,
characterized by the fact that
The relative change in position is carried out by shifting (d) (202) individual or grouped endohedral fullerenes (104,104′) along the orientation of the outer magnetic field (B) (109).

14. An arrangement structured as a spin based quantum computer for practicing the method of one of claims 1 to 13 for the processing of quantum mechanical data units by their coding in the spin position which may be affected in an outer magnetic field by irradiated electromagnetic pulses of resonance frequency, of addressable spins locally associated with a substrate with a control of the resonance frequency of the individual spins and the electromagnetic coupling between neighboring spins with local addressing control accesses for controlling the resonance frequency of the individual spins and local coupling control accesses for controlling the electromagnetic coupling between neighboring spins,
characterized by the fact that
the addressable spins are formed by electron spins (106) of free atoms enclosed in the interior of the cage of endohedral fullerenes (104, 304, 305, 306) of the same or different structure which, including the substrate (101, 301) are rigidly connected to each other in a matrix of two- or three-dimensional expression at a predetermined spacing (a) (300,300′) and that the addressing and/or coupling control accesses (103, 303) are structurally formed in correspondence with the selected kind of control of the resonance frequency (ω) of the individual spins (106) and the electromagnetic coupling (J) between neighboring spins (106).

15. The arrangement of claim 14,
characterized by the fact that
a control voltage is applied by way of addressing control accesses for controlling the resonance frequencies of the individual electron spins, which control voltage results in an electron transfer to the fullerene form the substrate or from an electrolyte which is surrounding the fullerenes.

16. The arrangement of claim 14,
characterized by the fact that
for the control of the resonance frequencies of individual electron spins by an electron transfer from polymer based donor molecules the donor molecules are connected to the endohedral fullerenes by direct chemical bonding or by polymer based feed lines and that a control voltage is applied by way of addressing control accesses structured as electrodes.

17. The arrangement of claim 14,
characterized by the fact that
for the control of the resonance frequencies of individual electron spins (106) by an electron transfer from polymer based light sensitive donor molecules (311, 312, 313) the donor molecules are connected by direct chemical bonding or by polymer based feed lines with the endohedral fullerenes (104) and that an excitation light current is generated by way of the addressing control accesses structured as a light source.

18. The arrangement of one of claims 14 to 17,
characterized by the fact that
with statically distinguishable electron spins there is provided a common addressing control access.

19. The arrangement of one of claims 14 to 18,
characterized by the fact that
the endohedral fullerenes structured as oligo, polymer or chemically bonded fullerenes are structured with defined dipole couplings and are arranged in the matrix, particularly in an oriented manner.

20. The arrangement of claim 19,
characterized by the fact that
the endohedral fullerenes (304) are arranged in the matrix on the substrate (301) as linear chains (401, 402) with uniform spacings (a) between individual fullerenes (304), at the junctions or individually or in linear or coupled chains along the meshes of grids of uniform honeycomb structure in a web-like matrix.

21. The arrangement of claim 19 or 20,
characterized by the fact that
for controlling the electromagnetic coupling between neighboring electron spins by tilting (β, θ) of the outer magnetic field (B) (109) or of the substrate (101) with which the endohedral fullerenes are locally associated, the coupling control accesses are structured as corresponding tilting mechanisms, particularly when tilting of substrate areas structured as liquid crystals.

22. The arrangement of claim 19 or 20,
characterized by the fact that
for controlling the electromagnetic coupling (J) between neighboring electron spins (106) by changing the effective orientation of the outer magnetic field (B) (109), the coupling control accesses are structured as additional fields orthogonal with respect to the quanticising main field.

23. The arrangement of claim 19 or 20,
characterized by the fact that
for controlling the electromagnetic coupling (J) between neighboring electron spins (106) by shifting (d) (203) of individual or grouped endohedral fullerenes (104,104′) along the orientation of the outer magnetic field (B) (109) the coupling control accesses which affect the fullerenes or group of fullerenes are structured as piezo electric or vibrating elements of structural components for generating surface sound waves.

24. The arrangement of one of claims 19 to 23,
characterized by the fact that
with statically distinguishable electromagnetic couplings between neighboring electron spins there is provided for each coupling an individual coupling control access structured to correspond to the selected kind of control for the coupling and to cover all the electron spins.
